(19) United States
(12) Patent Application Publication
(10) Pub. No.: US 2006/0289440 A1
(43) Pub. Date: Dec. 28, 2006

(54) Hygienic wipes steamer

(76) Inventors: Thomas E. McConnell, Santa Ynez, CA (US); Francois P. Hacquard, Los Angeles, CA (US); Joseph Merchant, Lake Forest, CA (US); Timothy Payne, Santa Ana, CA (US); Earl Robinson, Lake Forest, CA (US); Andrew Scherer, Trabuco Canyon, CA (US)

Correspondence Address: STETINA BRUNDA GARRED & BRUCKER, 75 ENTERPRISE, SUITE 250, ALISO VIEJO, CA, 92656, US

(21) Appl. No.: 11/406,779

(22) Filed: Apr. 19, 2006

Related U.S. Application Data
(63) Continuation-in-part of application No. 11/103,776, filed on Apr. 12, 2005.
Application No. 11/103,776 is a continuation of application No. 10/958,030, filed on Oct. 4, 2004, now Pat. No. 6,903,307.

(51) Int. Cl. A21B 1/22

(52) U.S. Cl. 219/401

(57) ABSTRACT

Provided is a hygienic wipes steamer having a housing assembly with a liquid container and a generally planar heater assembly being supported thereby. The housing assembly may be configured for supporting either a stack of individual sheets of hygienic wipes material or a roll of hygienic wipes material. The individual sheets of both the roll and the stack are preferably arranged in detached relationship to one another and are successively delivered to the heater assembly. A wipes transporter may be further included within the housing assembly and is operative to successively engage the uppermost one of the individual sheets of the stack for transportation to the heater assembly. Alternatively, a roller assembly may be included with the housing assembly and is preferably operative to deliver individual sheets to the heater assembly prior to warming and moisturizing thereof.

### CROSS-REFERENCE TO RELATED APPLICATIONS

This is a continuation-in-part application of co-pending U.S. patent application Ser. No. 11/103,776 entitled HYGIENIC WIPES STEAMER, filed on Apr. 12, 2005, which is a continuation of U.S. patent application Ser. No. 10/958,030, entitled HYGIENIC WIPES STEAMER, filed on Oct. 4, 2004, now U.S. Pat. No. 6,903,307, the entire contents of each application being expressly incorporated by reference herein.

### STATEMENT RE: FEDERALLY SPONSORED RESEARCH/DEVELOPMENT

Not Applicable

### BACKGROUND OF THE INVENTION

The present invention relates generally to hygienic wipes warmers and, more particularly, to an improved hygienic wipes steamer that is specifically adapted to produce individual, warmed and moistened hygienic wipes from dry non-woven or paper material.

Hygienic wipes have been marketed in the United States for many years. Essentially, hygienic wipes are small pre-moistened paper or synthetic (non-woven) towelettes and are typically available in packages to the consuming public. They are used to cleanse the skin of infants and small children and are also referred to as baby wipes. The wipe fluid content for these pre-moistened wipes is generally comprised of cleansers, lotions and preservatives.

A few years after the hygienic wipes were introduced into the marketplace, various products for warming the wipes were made available to the public. Such products have been devised to comfort the hygienic wipes user from the inherent “chill” given off by the contact of the moistened wipes. For example, it is now a common practice for parents to employ the use of warm hygienic wipes (i.e., hygienic wipes) on their children.

These warming products are generally electrically-operated and are generally available in two distinct styles. One is an “electric blanket” style which is sized to wrap around the external surfaces of a plastic hygienic wipes container. The other is a self-contained plastic “appliance” style which warms the accommodated hygienic wipes with its internally positioned heating element. Though such currently known and available hygienic wipes warming products achieve their primary objective of warming hygienic wipes, they possess certain deficiencies which detract from their overall utility.

One significant deficiency of the prior art hygienic wipes warmers is their inability to quickly and thoroughly warm the hygienic wipes. The prior art hygienic wipes warmers are typically configured to position a heating element in general proximity to an area where the hygienic wipes are disposed. In this respect, the generated heat is merely conveyed to such area which then gradually and slowly diffuses itself there throughout so that the hygienic wipes can eventually be heated to the elevated temperature. However, even then, not all the hygienic wipes are adequately warmed as the heat often times does not reach the hygienic wipes disposed in the middle of a hygienic wipes stack. As such, the prior art hygienic wipes warmers expend a great amount of time in warming up the hygienic wipes, often with inadequate performance.

Another deficiency of the prior art hygienic wipes warming products is the inability to sustain the coloration of the hygienic wipes. More specifically, in prior art hygienic wipes warming products, discoloration or browning of the hygienic wipes occurs because of a reaction of various chemicals in the wipes to heating. As such, even though the prior art hygienic wipes warming products may adequately warm the hygienic wipes, they cannot, however, avoid the undesirable effects of discoloration when warming them.

In addition, prior art hygienic wipes warming products are limited in the temperature to which they can effectively heat the hygienic wipes because drying out of the hygienic wipes over time. Even further, prior art hygienic wipes warming products are by their nature often ineffective in heating the hygienic wipes to a sufficiently elevated temperature. More particularly, the heated hygienic wipes may only be heated up to body temperature due to rapid dissipation of heat when the hygienic wipes are exposed to open air.

An even further deficiency associated with prior art hygienic wipes warming products is associated with hygienic wipes that are provided in a stacked formation. In such an arrangement, each one of the hygienic wipes in the stack must be pre-cut to a specific size that is compatible with the particular hygienic wipes warming device. Furthermore, the pre-cut hygienic wipes must be layered in registration with one another (i.e., aligned) and/or pre-folded in the stack formation such that the stack will fit within the hygienic wipes warmer.

After heating, the individual hygienic wipes may then be withdrawn from the hygienic wipe warming device and/or unfolded for use. As may be appreciated, the necessity of precutting, pre-folding, and layering the hygienic wipes in registration increases the manufacturing costs associated with hygienic wipes. Such costs are ultimately passed on to the consumer during the purchase of hygienic wipes warmer and for subsequent refill purchases of the hygienic wipes. In addition, the warm, moist and dark environment within prior art hygienic wipes warming products provides a breeding ground for potentially harmful micro-organisms (e.g., germs).

Some prior art hygienic wipes warmers present another deficiency in the form of a safety hazard due to the inclusion of a hot water container within the hygienic wipes warmer. Such prior art hygienic wipes warmers operate by heating the container of water and then using hot water or steam from the heated water to warm a hygienic wipe. While this configuration of hygienic wipes warmer may be acceptable for use in certain commercial or institutional environments, the hot water in the container poses an unreasonable risk in a home environment. For example, it is foreseeable that a toddler could pull the hygienic wipes warmer off of a countertop or table with resulting scalding of the toddler by the hot water in the container.

Prior art hygienic wipes warmers of the type having the heated water container are additionally inconvenient from a time-efficiency standpoint. Such hygienic wipes warmers require a relatively lengthy waiting period (e.g., up to 30 minutes) from activation of the hygienic wipes warmer until a warmed hygienic wipe is produced. This is because the entire contents of the water container must be sufficiently heated in order to then heat the hygienic wipes to an acceptable temperature. Such lengthy waiting period may be unacceptable and impractical in certain situations such as those situations involving infant care.

Thus, there exists a substantial need in the art, and in the infant products manufacturing business in particular, for a hygienic wipes warming product that can effectively provide warmth to hygienic wipes without discoloration. Additionally, there exists a need in the art for a hygienic wipes warming product that can heat the hygienic wipes in a time-efficient manner. Additionally, there exists a need in the art for a hygienic wipes warming product that avoids the safety hazards associated with hot water containers as used in prior art hygienic wipes warmers. Also, there exists a need in the art for a hygienic wipes warming product that avoids the deficiencies associated with growth of micro-organisms in prior art prior art hygienic wipes warmers that use pre-moistened wipes. Finally, there exists a need in the art for a hygienic wipes warming product that can achieve these objectives in a user-friendly and cost-effective manner.

### BRIEF SUMMARY

The present invention specifically addresses the above-referenced needs associated with hygienic wipes steamers. More specifically, the present invention is a hygienic wipes steamer that is specifically adapted to provide individual, warmed and moistened hygienic wipes from either a stack or a roll of dry, non-woven or paper material. Furthermore, regardless of whether the starting material is provided in stacked or rolled form, the various embodiments of the hygienic wipes steamer as described herein provides for the heating of individual hygienic wipes on a generally planar heating assembly to avoid the complexities associated with rolling the hygienic wipes on a heater tube and ejecting the rolled hygienic wipes out of the hygienic wipes steamer. In one aspect of the invention, the hygienic wipes steamer is configured to produce a hygienic wipe from an individual sheet taken from a stack of material.

In its broadest sense, each of the embodiments of the hygienic wipes steamer as described below includes a housing assembly, a liquid container and a generally planar heating assembly supported by the housing assembly. The liquid container may be supported by or mounted within the housing assembly and preferably includes provisions for detecting liquid level in the liquid container. The heating assembly is operative to receive liquid from the liquid container and vaporize at least a portion thereof for moisturizing and warming the individual sheets in one-at-a-time fashion.

As was earlier mentioned, the hygienic wipes steamer may be configured to support a stack of individual sheets of hygienic wipes material that is preferably arranged with the sheets being detached from one another such that no cutting mechanism is necessary. In an alternative embodiment, the individual sheets may be drawn from a roll of hygienic wipes material mounted within the housing assembly. The roll of hygienic wipes material may be comprised of individual sheets that are wound upon the roll but which are separated from one another upon unwinding from the material roll. In this regard, opposing ends of the individual sheets may be disposed in generally close abutting or slightly overlapping relationship to one another. Alternatively, the material roll may include spaced rows of perforations which extend across a width of the material such that upon unwinding, the roll of material may be partitioned into individual sheets.

The liquid container may be either integrally formed with the heater assembly or separately mounted within or upon the housing assembly. Liquid drawn from the liquid container may be provided to a heating element included with the heater assembly such that the liquid may be vaporized in order to warm and moisten individual sheets of the hygienic wipes. A pump unit may be provided to draw water from the liquid container for delivery to the heating element of the heater assembly.

The hygienic wipes steamer may further include a wipes transporter which is operative to successively deliver individual sheets from the stack to the heater assembly for moisturizing thereof. The wipes transporter may be configured as a grabber assembly and may be operative to engage individual sheets from the stack and release the sheets at the heater assembly. The wipes transporter may be configured as a grabber assembly which may be transversely reciprocatively mounted on a transporter drive screw mounted adjacent an upper portion of the hygienic wipes steamer.

The grabber assembly itself may be configured as a suction cup assembly or other suitable device specifically configured to engage, such as by suction, individual sheets from the stack for lateral transportation to the heater assembly. Operation of the wipes transporter may be regulated by means of a control circuit which may be pre-programmed to generate a pre-determined quantity (e.g., a single sheet or multiple sheets) of hygienic wipes upon activation of the hygienic wipes steamer.

Alternatively, in an alternative embodiment of the invention, the individual sheets of hygienic wipes material may be wound onto the roll in detached relationship to one another. The material roll may include spaced perforations to facilitate separation of the individual sheets from one another. In such an arrangement, the hygienic wipes steamer may further include a roller assembly having a pair of rollers that are operative to pinch successive ones of the individual sheets therebetween in order to facilitate one-at-a-time delivery of the individual sheets to the heater assembly.

Separation of the material roll along the pre-formed perforations is preferably facilitated by temporarily halting rotation of one of the pairs of pinch rollers while continuing rotation of the other one of the pairs. In this manner, the individual sheets may be sequentially delivered to the heater assembly. Upon moisturizing (i.e., steaming), the individual sheet is ejected out of the housing assembly through a wipes aperture formed therein.

The cycle may be repeated such that either a single one of the individual sheets is steamed and dispensed from the hygienic wipes steamer or a pre-determined quantity of sheets is steamed and ejected out of the hygienic wipes steamer. The hygienic wipes steamer may be manually shut off or an automatic shut-off may be pre-programmed to occur at a pre-determined length of time following the most recent steaming of a hygienic wipes. Alternatively, a hygienic wipes steamer may automatically transition into a sleep mode.

### BRIEF DESCRIPTION OF THE DRAWINGS

These as well as other features of the present invention will become more apparent upon reference to the drawings wherein:

FIG. 1 is a partial cross sectional side view of a hygienic wipes steamer in a first embodiment having a housing assembly with a stack of hygienic wipes material mounted there within and also having a generally planer heater assembly configured for moisturizing individual sheets of the hygienic wipes material in a successive manner;

FIG. 2 is a cross sectional side view of the hygienic wipes steamer of the first embodiment and further illustrating a wipes transporter configured as a suction cup assembly operative to successively transport individual sheets from the stack to the heater assembly;

FIG. 3 is a perspective view of the hygienic wipes steamer in a second embodiment wherein a roll of the hygienic wipes material is delivered to the heater assembly in a successive manner for moisturizing and warming the individual sheets;

FIG. 4 is a cross sectional side view of the hygienic wipes steamer of the second embodiment illustrating a roller assembly that is operative to deliver individual sheets from the roll of hygienic wipes material to the heater assembly;

FIG. 5 is a perspective view of the hygienic wipes steamer of the second embodiment incorporating a liquid container into the housing assembly for delivery via a pump unit to a planar heating assembly;

FIG. 6 is a cross sectional side view of the hygienic wipes steamer of the first embodiment wherein the wipes transporter is configured as a jaw mechanism configured to engage an uppermost one of the stack of wipes arranged in inclined formation; and

FIG. 7 is a cross sectional side view of the hygienic wipes steamer of the first embodiment wherein the wipes transporter is configured as a pusher assembly having a high-friction element for engaging the uppermost one of the stack of wipes.

### DETAILED DESCRIPTION

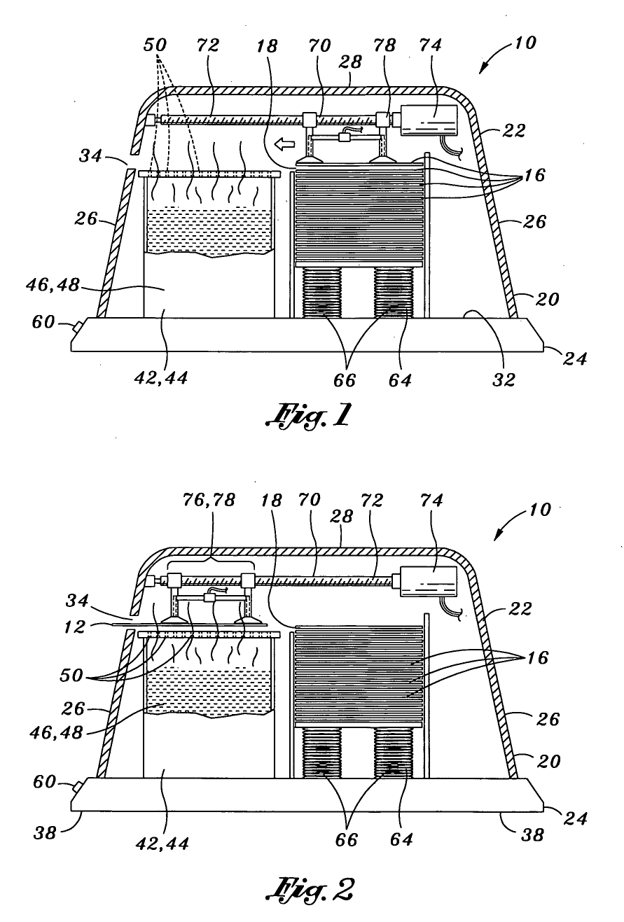

Referring now to the drawings wherein the showings are for purposes of illustrating preferred embodiments of the present invention only, and not for purposes of limiting the same, FIGS. 1-7 illustrate a hygienic wipes steamer 10 constructed in accordance with various aspects of the present invention. FIGS. 1-2 and 6-7 illustrate the hygienic wipes steamer 10 in a first embodiment specifically adapted to generate warmed hygienic wipes from a stack of starting material. FIGS. 3-5 illustrate the hygienic wipes steamer 10 in a second embodiment specifically adapted to generate warmed hygienic wipes from a roll of starting material. As was indicated above, the hygienic wipes steamer 10 is adapted to provide individual, warm and moistened hygienic wipes 12 from dry, non-woven or paper material or other suitable material.

In its broadest sense, the hygienic wipes steamer 10 comprises the housing assembly 20, a liquid container 42 and a generally planar heater assembly 46, all of which are disposed within the housing assembly 20. Advantageously, the hygienic wipes steamer 10 is configured such that an individual sheet 16 of hygienic wipe 12 may be quickly produced upon activation of the hygienic wipes steamer 10 allowing the individual sheets 16 to be produced in a cost effective manner using a stack or roll of material.

Referring to FIGS. 1-2 and 6-7, shown is the housing assembly 20 which may be constructed similar to that disclosed in U.S. Pat. No. 6,903,307 issued to McConnell et al., (the McConnell '307 reference) the entire contents of which are expressly incorporated by reference herein. More particularly, the housing assembly 20 may include a housing base 24 which is secured to a housing body 22. A base cover plate 32 maybe disposed on one side of the housing assembly 20 to allow for access to an interior of the housing base 24 within which certain components may be housed. Foot pads 38 may be mounted an opposite side of the housing assembly 20 for non-slidably supporting the hygienic wipes steamer 10 such as on a kitchen or bathroom countertop.

The housing body 22 may include a pair of opposed, spaced housing side walls 26, housing end walls 30, and housing top wall 28 which collectively define an interior housing compartment within which the liquid container 42 and generally planar heater assembly 46 are contained. A support wall 36 may be included in the housing assembly 20 for mounting a roller assembly 54 or other components thereto. For the hygienic wipes steamer 10 of the first embodiment, the housing assembly 20 is configured for supporting a stack of individual sheets 16 of hygienic wipes 12 material. The individual sheets 16 may be arranged similar to a stack of paper wherein the sheets 16 are detached from one another.

Also contained within the housing assembly 20 is the liquid container 42 which may be integrally formed with the heater assembly 46 as shown in FIG. 5 or which may be mounted within the housing assembly 20 as a separate component. For the latter, it is contemplated that the liquid container 42 is configured as an elongate, generally vertically-oriented housing member having a fill port disposed at an upward end thereof and which is accessible through the housing top wall 28. In this regard, the liquid container 42 may be refilled with liquid simply by applying liquid through an aperture formed in the housing top wall 28. The hygienic wipes steamer 10 may be configured such that the liquid container 42 is visible through the side walls 26 or end wall 30 in order to allow for visual observation of the level of the liquid within the liquid container 42.

The liquid container 42 may be fabricated of any suitable material and is preferably fabricated such as by an injection molding process. In order to prevent the growth of microorganisms, the liquid container 42 may be fabricated of plastic that includes an anti-microbial additive. A pump unit 44 may be included with the housing assembly 20 as shown in FIG. 5 and is preferably configured to pump liquid from the liquid container 42 into the heater assembly 46. Also shown in FIG. 5 are liquid conduits fluidly connecting the pump unit 44 to the heater assembly 46 to facilitate such pumping of liquid. As will described in greater detail below, when the hygienic wipes steamer 10 is activated, as may be indicated by the activation/indication mechanism 60 disposed adjacent to the housing base 24, a heating element 48 included with the heater assembly 46 may be warmed to allow for vaporization of liquid from the liquid container 42 in order to warm and moisten individual sheets 16 of the hygienic wipes 12.

Referring still to FIGS. 1-2 and 6-7, the hygienic wipes steamer 10 of the first embodiment may further include a wipes transporter 70 disposed within the housing assembly 20 and which is operative to successively deliver individual sheets 16 from the stack to the heater assembly 46 for heating thereof. The wipes transporter 70 may be configured as a grabber assembly 76 which is operative to engage individual sheets 16 from the stack and release the individual sheets 16 at the heater assembly 46. The wipes transporter 70 may comprise a transporter motor 74 rotatably coupled to a transporter drive screw 72 upon which may be mounted the grabber assembly 76.

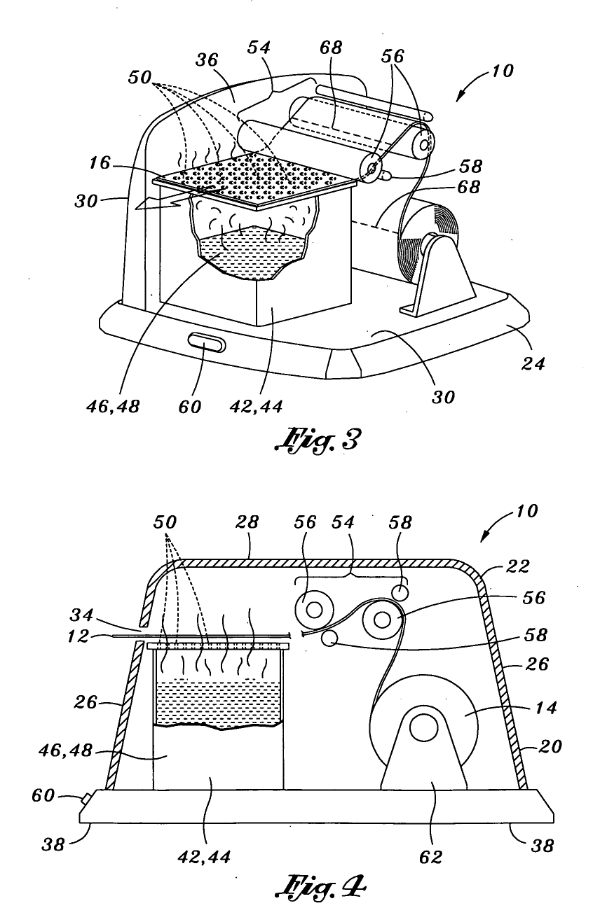

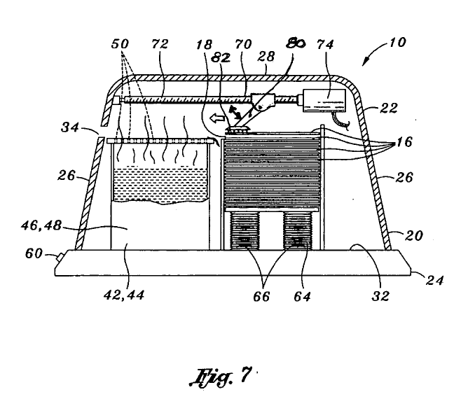

The grabber assembly 76 may be configured in a variety of embodiments including a suction cup assembly 78 shown in FIGS. 1 and 2 or a pusher assembly shown in FIGS. 6 and 7. The suction cup assembly 78 is specifically configured to successively engage, by suction, individual sheets 16 from the stack. The wipes transporter 70 is further configured to laterally transport one of the individual sheets 16 from the stack to the heater assembly 46 and then disengage or release the individual sheet 16 upon a heater surface of the heater assembly 46.

Operation of the wipes transporter 70 may be regulated by means of a control circuit having a pre-programmed or programmable microprocessor for regulating various operating parameters. For example, the transporter motor 74 may be operated in such a manner as to reciprocate laterally back and forth via the transporter drive screw 72 in order to move the suction cup assembly 78 back and forth from the stack to the heater assembly 46. The cycle may be repeated a predetermined number of times or according to user input.

The heater assembly 46 may include the heating element 48. Upon activation of the hygienic wipes steamer 10, the heating element 48 is warmed to a predetermined or a user-set temperature that is preferably sufficient to vaporize liquid from the liquid container 42. In this regard, the heater assembly 46 may be configured similar to that which is disclosed in U.S. Pat. No. 6,674,048 issued to McConnell et al., (the McConnell '048 reference) the entire contents of which are expressly incorporated by reference herein. The heater assembly 46 may include a support surface upon which may be mounted a sponge layer for retaining liquid therein. The heating element 48 is preferably operative to heat liquid contained within the sponge layer in order to transition the liquid into hot water or heated vapor. The heater assembly 46 may include a surface having steam holes 50 formed therein in order to allow vapors generated by the heating element 48 to be absorbed by the individual sheet 16.

The surface of the heater assembly 46 is preferably configured to allow for moisturizing of the individual sheet 16 resting thereon while allowing for easy removal of the individual sheet 16 once sufficiently warmed. In this regard, a suitable coating or surface texture is preferably provided to the heater assembly 46 surface. As shown in the McConnell '048 reference, the support surface may be configured as a suspension tray with the sponge layer being positionable thereupon. In this manner, liquid contained within a liquid reservoir may be absorbed into the sponge layer to allow for moistening of the individual sheet 16 of hygienic wipe 12. The heating element 48 disposed within the heater assembly 46 is preferably operative to generate steam from the liquid in order to steam the individual sheets 16.

Once sufficiently warmed and moistened, the individual sheet 16 may be ejected out of the housing assembly 20 through the housing side wall 26 via a wipe aperture 34 formed within the housing side wall 26, as is shown in FIGS. 1 and 2. However, the hygienic wipes steamer 10 may be configured such that the individual sheets 16 may be dispensed out of any location of the housing assembly 20. In this regard, the individual sheets 16 may be dispensed out of the housing end wall 30, through the housing top wall 28 or through the housing side wall 26.

Referring still to FIGS. 1-2 and 6-7, the stack of individual sheets 16 of hygienic wipes 12 material may be supportably mounted on a stack support 64. A biasing member 66 such as a compression spring interposed between the housing base 24 and a stack support 64 plate may bias the stack upwardly to facilitate engagement of the individual sheets 16 by the wipes transporter 70. In this manner, an uppermost one of the individual sheets 16 from the stack may be positioned at a height sufficient to allow engagement thereof by the wipes transporter 70 followed by lateral transitioning to the heater assembly 46.

The stack may be mounted within stack guides that maintain registration between adjacent sheets. Only the uppermost one of the individual sheets 16 is preferably removed from the stack in one-at-a-time fashion. In this manner, inadvertent engagement of multiple ones of the individual sheets 16 is prevented. The biasing member 66 is preferably configured to maintain the stack such that the uppermost one of the individual sheets 16 is moved to a predetermined level complementary to (i.e., that is aligned with) the positioning of the wipes transporter 70.

Referring briefly now to FIG. 6, it is further contemplated that the stack may be arranged in inclined formation such that each one of the individual sheets 16 has a leading edge 18 that is at least partially extended beyond the leading edge 18 of a next lower one of the individual sheets 16. In this configuration, the grabber assembly 76 is preferably configured to engage the leading edge 18 of the uppermost one of the individual sheets 16 by means of a closeable jaw mechanism or set of jaw mechanisms. The jaw mechanism may by supported or suspended by a screw drive similar to that show in FIGS. 1 and 2 and which is effective to laterally translate the jaw mechanism in coordination with opening and closing of jaw elements of the jaw mechanism to alternately engage and disengage the individual sheets 16.

As shown in FIG. 6, the jaw mechanism is configured to open and thereby receive the leading edge 18 of the uppermost one of the individual sheets 16. The leading edges 18 are preferably disposed on a left-hand side of the stack although it is contemplated that engagement of the leading edge 18 may occur on the right-hand side thereof. The jaw mechanism is also preferably configured to open for disengaging the individual sheet 16 at the heater assembly 46 at the appropriate time. Upon engagement, the grabber assembly 76 is preferably configured to pull the individual sheet 16 from the stack towards the heater assembly 46 and release the individual sheet 16 upon the heater assembly 46 for warming and moisturizing thereof.

Referring briefly now to FIG. 7, it is further contemplated that the wipes transporter 70 may be configured as a pusher assembly 80 to push the uppermost one of the individual sheets 16 from the stack to the heater assembly 46. In this regard, it is contemplated that the pusher assembly 80 has at least one high-friction element 82 which engages the individual sheet 16 and may include at least one surface-roughed or textured pad that is placed into contact with the uppermost one of the individual sheets 16.

The high-friction element 82 may include teeth or other engaging elements inclined in a direction toward the heater assembly 46 and which are effective to engage or pick up the individual sheet 16. Due to the inclined angle of the teeth, reversal of the pusher assembly 80 allows the individual sheet 16 to slide off the teeth. Simultaneous with the release of the individual sheet 16, the pusher assembly 80 is preferably configured to lift or rise slightly above the level of the stack and then lower again during engagement of another one of the individual sheets 16.

The pusher assembly 80 may further be operatively coupled to the drive screw which is rotatable by means of a motor similar to that described above. Upon activation, the pusher assembly 80 may be operative to engage the uppermost one of the individual sheets 16 with the high friction pads whereupon rotation of the transporter drive screw 72 effectuates lateral translation of the high friction pads. In this manner, the uppermost one of the individual sheets 16 may be moved from the stack to the heater assembly 46. After release on the heater assembly 46, the high friction pads may be slightly lifted and then laterally translated back due to reverse rotation of the transporter drive screw 72 by the transporter motor 74. The cycle may be repeated depending upon the number of individual sheets 16 to be warmed and moistened.

Referring now to FIGS. 3-5, shown is the hygienic wipes steamer 10 in a second embodiment wherein the individual sheets 16 are drawn from the roll of hygienic wipes 12 disposable within the housing assembly 20. A pair of roll mounts 62 may be connected to the housing assembly 20 such as the housing base 24 wherein the roll may be supported similar to that shown and described in the McConnell '307 reference, as was earlier mentioned. The roll of hygienic wipes 12 material may be comprised of individual sheets 16 wound upon the roll such that the hygienic wipes 12 are separated from one another upon unwinding from the material roll 14.

The individual sheets 16 may be wound onto the roll in detached relationship to one another. In this regard, opposing ends of each one of the individual sheets 16 may be disposed in generally abutting or slightly overlapping relationship to one another as shown in FIG. 5. Alternatively, the material roll 14 may include spaced rows of pre-formed perforations extending transversely across a width of the material as shown in FIG. 3 such that unwinding of the roll allows for partitioning of the material into the individual sheets 16. The hygienic wipes steamer 10 may include a roller assembly 54 as shown in FIGS. 3-5 in order to facilitate separation of the individual sheets 16.

The roller assembly 54 may include a pair of rollers each having pinch rollers 58 disposed adjacent thereto in order to temporarily capture successive ones of the individual sheets 16 therebetween. Pinch rollers 58 may also be positioned adjacent to the material roll 14 to facilitate unwinding of sheets 16 that have overlapping edges. Preferably, the roller assembly 54 is operatively regulated by the appropriate control circuitry and programming to facilitate delivery of the individual sheets 16 to the heater assembly 46 in generally uniformly-spaced relationship to one another. In this regard, the roller assembly 54 is preferably configured such that once the individual sheet 16 is delivered to the heater assembly 46, rotation of the roller assembly 54 may temporarily cease to allow sufficient time for moisturizing and warming the individual sheet 16 prior to ejection thereof from the housing assembly 20.

Furthermore, for the roll having the pre-formed partitions, separation of the individual sheets 16 from one another may be facilitated by cooperation between the adjacent pairs of rollers and pinch rollers 58, as shown in FIG. 3-5. More specifically, upon threading of the leading edge 18 of a material through the roller and pinch roller 58 shown on the right hand side of the roller assembly 54 in FIG. 3, the leading assembly is then threaded through the left hand pinch roller 58 and roller combination. Separation of the material roll 14 along a pre-formed perforation is facilitated by temporarily halting rotation of the right most roller/pinch roller assembly 54 while continuing rotation of the left most roller/pinch roller assembly 54 when the pre-formed perforations are interposed between the left most and right most roller/controller assemblies 54. In this manner, the individual sheet 16 may be delivered to the heater assembly 46 for moisturizing and warming thereof.

The configuration of the heater assembly 46 and liquid container 42 for the second embodiment is similar to that described above for the hygienic wipes steamer 10 of the first embodiment. The operation of the hygienic wipes steamer 10 of the first and second embodiments will now be described with reference to FIGS. 1-7.

Prior to activation of the hygienic wipes steamer 10 such as via the activation/indication mechanism 60, the material of hygienic wipes 12 may be initially loaded into the housing assembly 20. For the first embodiment shown in FIGS. 1-2 and 6-7, the material stack of individual sheets 16 is inserted between the stack guides such that it is supported by the stack support 64 with a biasing member being configured to maintain the uppermost one of the individual sheets 16 in complementary vertical alignment with the wipes transporter 70. The liquid container 42 may be filled with a desired amount of liquid which may include anti-bacterial additives, lotions, or other additives. In addition, the stack of hygienic wipes 12 material may be pre-treated with similar anti-microbial additives, lotions, or other materials.

The liquid in the liquid container may simply comprise water but other liquids may be utilized. Upon activation of the hygienic wipes steamer 10, power is provided to the heating element 48 which may be configured as an electrically powered element. Once the heating element 48 reaches a predetermined temperature, the activation/indication mechanism 60 may indicate that the heating element 48 is sufficiently warmed. It is contemplated that the time period required for sufficiently heating the heating element 48 may be in the range of about 10-15 seconds although more or less time may be required to sufficiently heat to the desired temperature.

Once the heating element 48 is sufficiently warmed, activation of the hygienic wipes steamer 10 to initiate movement of the wipes transporter 70 may be effectuated manually or autonomously. The wipes transporter 70 is then operative to successively transport the uppermost one of the individual sheets 16 from the stack to the heater assembly 46 for moisturizing and warming thereof. If the liquid container 42 is formed as a separate unit from the heater assembly 46, activation of the pump unit 44 would cause liquid from the liquid container 42 to flow to the heating element 48 for vaporization of the liquid. A predetermined quantity of liquid may be injected into the heater assembly 46 which is then flashed by the heating element 48 into steam upon exposure thereto. The steam then passes through steam holes 50 formed in the heater assembly 46 to warm and irrigate the individual sheet 16. The individual sheet 16 is then ejected out of the housing assembly 20 through the wipes aperture as shown in FIG. 2.

Prior to ejection of the hygienic wipe 12, if an additional sheet 16 of hygienic wipe 12 material is to be warmed, the wipes transporter 70 moves laterally back toward the stack and again engages the uppermost one of the individual sheets 16. The cycle may be repeated such that the individual sheets 16 are steamed and dispensed from the hygienic wipes steamer 10 in one-at-a-time fashion. The hygienic wipes steamer 10 may be further configured to automatically shutoff after a predetermined length of time (e.g., 30 seconds) or the hygienic wipes steamer 10 may automatically transition into a sleep mode.

Alternatively, a predetermined number of hygienic wipes 12 may be may be steamed and dispensed either by preprogramming or via manual quantity selection, prior to automatic shutoff. A processor or microprocessor may be preprogrammed to activate the wipes transporter 70 and heater assembly 46 in synchronized mode with one another such that individual sheets 16 may be efficiently prepared, steamed and ejected out of the hygienic wipes steamer 10. Furthermore, the processor may be preprogrammed to automatically shutoff after processing a certain quantity of hygienic wipes 12. The processor may also be configured to control the pump unit 44 in synchronization with the other components.

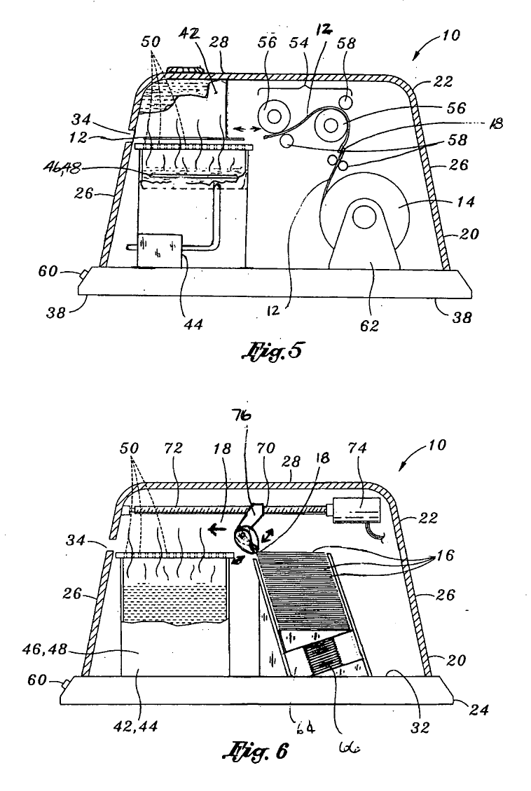

The operation of the hygienic wipes steamer 10 of the second embodiment will now be described with reference to FIGS. 3-5. Prior to activation of the hygienic wipes steamer 10, the material roll 14 may be mounted within the housing assembly 20 on the roll mounts 62. Preferably, the material roll 14 is oriented such that unwinding of the leading edge 18 of the material is from a side opposite the adjacent one of the housing side walls 26, as is shown in FIG. 4.

The leading edge 18 of the material roll 14 may then be threaded upwardly toward the right most one of the roller assemblies 54 (i.e., either manually or automatically) and through the left most one of the roller assemblies 54 as shown in FIG. 4. Such threading may be facilitated by inserting the leading edge 18 between the feed roller 56 and pinch rollers 58 of left most and right most roller assemblies 54. It is contemplated that the activation/indication mechanism 60 may result in rotation of the roller assemblies 54 to cause automatic threading of a fixed amount of the leading edge 18 of the material roll 14.

The liquid container 42 may be filled with a desired amount of liquid as was described above. With the heating element 48 at a predefined temperature, the left most and right most ones of the roller assemblies 54 may be operated so as to successively deliver individual sheets 16 onto the heating assembly for moisturizing thereof. In this regard, the processor may be configured to allow sufficient time for the individual sheet 16 on the heater assembly 46 to absorb the appropriate amount of heat prior to ejection of the individual sheet 16 out of the housing assembly 20.

As was earlier mentioned for the stack for the first embodiment, the material roll 14 for the second embodiment of the hygienic wipes steamer 10 may be provided in a pretreated condition. For example, the material roll 14 may be treated with various aloes and lotions for babies, infants, toddlers and children. For teenagers, the material roll 14 may be treated to be effective against certain types of skin conditions. Furthermore, the hygienic wipes steamer 10 may be configured to receive various size material rolls 14 such as a toilet paper roll or a paper towel roll. The toilet paper roll may be pretreated with various lotions, ointments and other preparations.

Additional modifications and improvements of the present invention may be also apparent to those of ordinary skill in the art. Thus, the particular combination of parts described and illustrated herein is intended to represent only certain embodiments of the present invention and is not intended to serve as limitations of alternatively devices within the spirit and scope of the invention.

What is claimed is:

1. A hygienic wipes steamer, the steamer comprising:
a housing assembly configured for supporting a stack of individual sheets of hygienic wipes material;
a liquid container supported by the housing assembly and being configured to store a quantity of liquid; and
a generally planar heater assembly supported by the housing assembly and being operative to receive liquid from the liquid container and vaporize at least a portion thereof for moisturizing and warming the individual sheets.

2. The hygienic wipes steamer of claim 1 wherein the individual sheets are arranged in detached relationship to one another.

3. The hygienic wipes steamer of claim 1 further comprising a wipes transporter disposed within the housing assembly and being operative to successively transport individual sheets from the stack to the heater assembly.

4. The hygienic wipes steamer of claim 3 wherein the wipes transporter is configured as a grabber assembly operative to engage the individual sheet at the stack and release the individual sheet at the heater assembly.

5. The hygienic wipes steamer of claim 4 wherein the wipes transporter is configured as a suction cup assembly configured to successively lift the individual sheets from the stack and release the individual sheet onto the heater assembly.

6. The hygienic wipes steamer of claim 4 wherein:
the stack is arranged in inclined formation such that each one of the individual sheets has a leading edge that is at least partially extended beyond the leading edge of a next lower one of the individual sheets;
the grabber assembly being configured to engage the leading edge of the uppermost one of the individual sheets and pull the individual sheet from the stack to the heater assembly.

7. The hygienic wipes steamer of claim 1 wherein the heater assembly includes at least one steam hole formed therealong and through which vapor passes to moisturize and warm the individual sheets.

8. The hygienic wipes steamer of claim 7 wherein the heater assembly includes a heating element disposed therewithin for generating steam from the liquid for steaming the individual sheets.

9. The hygienic wipes steamer of claim 1 wherein the liquid container is formed from plastic having an anti-microbial additive.

10. The hygienic wipes steamer of claim 1 wherein the housing assembly is fabricated from a plastic material.

11. A hygienic wipes steamer, the steamer comprising:
a housing assembly configured for supporting a roll of hygienic wipes material;
a liquid container supported by the housing assembly and being configured to store a quantity of liquid; and
a generally planar heater assembly supported by the housing assembly and being operative to receive liquid from the liquid container and vaporize at least a portion thereof for moisturizing and warming individual sheets of the hygienic wipes material.

12. The hygienic wipes steamer of claim 11 wherein the individual sheets are wound onto the roll in detached relation to one another.

13. The hygienic wipes steamer of claim 12 wherein the material includes spaced rows of preformed perforations extending across a width of the material for partioning into the individual sheets.

14. The hygienic wipes steamer of claim 11 further comprising:
a roller assembly disposed within the housing assembly;
wherein:
the roller assembly is configured to receive material unwinding from the roll and successively partition the material into individual sheets;
the roller assembly being operative to deliver the individual sheets to the heater assembly.

15. The hygienic wipes steamer of claim 14 wherein the roller assembly includes a pinch roller engageable to an adjacent feed roller for capturing the material therebetween during unwinding of the roll.

16. The hygienic wipes steamer of claim 11 wherein the heater assembly includes at least one steam hole formed therealong and through which vapor passes to moisturize and warm the individual hygienic wipes.

17. The hygienic wipes steamer of claim 16 wherein the heater assembly includes a heating element disposed therewithin for generating steam from the liquid for steaming the individual hygienic wipes.

18. The hygienic wipes steamer of claim 11 further comprising a pump unit operative to pump fluid to the heater assembly.

19. The hygienic wipes steamer of claim 11 wherein the liquid container is formed from plastic having an anti-microbial additive.

20. The hygienic wipes steamer of claim 11 wherein the housing assembly is fabricated from a plastic material.
